(19) United States
(12) Patent Application Publication
(10) Pub. No.: US 2023/0036365 A1
(43) Pub. Date: Feb. 2, 2023

(54) VALVE

(71) Applicants: AUROTEC GMBH, Regau (AT); NORDSON CORPORATION, Westlake, OH (US)

(72) Inventors: Helmut HERMANN, Drensteinfurt (DE); Stefan WÖSTMANN, Sassenberg (DE); Michael LONGIN, Bad Mitterndorf (AT); Stefan ZIKELI, Regau (AT)

(21) Appl. No.: 17/758,619

(22) PCT Filed: Jan. 21, 2021
(86) PCT No.: PCT/EP2021/051236

§ 371 Date: Jul. 11, 2022

(30) Foreign Application Priority Data
Jan. 21, 2020 (EP) 20152893.2

(51) Int. Cl. B29C 48/05; B29C 48/00; B29C 48/25; B29C 48/255; B29C 48/08; B29C 48/10

(52) U.S. Cl. CPC B29C 48/05; B29C 48/08; B29C 48/10; B29C 48/022; B29C 48/269; B29C 48/2528; B29C 48/2552

(57) ABSTRACT

A valve having a valve housing and a blocking element, wherein the valve housing has a hollow space for receiving the blocking element, an inlet opening for allowing a fluid to flow into the hollow space and an outlet opening for allowing the fluid to flow out of the hollow space, wherein the blocking element has a guide body and is arranged linearly moveably and at least partially in the hollow space of the valve housing between the inlet opening and the outlet opening, wherein the blocking element has at least one opening for allowing the fluid to flow from the inlet opening to the outlet opening via the opening.

The invention relates to a valve comprising a valve housing and a shut-off element, wherein the valve housing comprises a cavity for receiving the shut-off element, an inlet opening for a fluid to flow into the cavity and an outlet opening for the fluid to flow out of the cavity, wherein the shut-off element comprises a guide body and is arranged linearly movably at least partially in the cavity of the valve housing between the inlet opening and the outlet opening.

In many technical manufacturing processes it is desirable to operate on a continuous flow basis with constantly full and/or partially filled material feed lines. An example for this is the manufacture of formed cellulose products such as fibres, foils, films from the renewable raw material cellulose. In this manufacturing process formed cellulose articles are manufactured by forming cellulose solutions in an organic solvent and by spinning the cellulose/solution melts for forming a fibre or a film. A preferred form of the solvent is a tertiary amine-N-oxide, typically N-methyl morpholine N-oxide (NMMO). These cellulose solutions are usually highly viscous, having a viscosity of typically 50,000 to 10,000,000 mPas. Such a cellulose solution manufacturing process is described in EP 0 356 419 B1. A problem with the processing of cellulose solutions is the high processing temperature required (usually 80° C. to 130° C.) and the instability of the cellulose solution at these temperatures. It is therefore desirable to operate free of dead space and free from stagnation.

Various forms of valves are known in the prior art. DE 38 15 897 C2 discloses a starting valve throttle unit with a discharge channel which widens to an extrusion tool. Provided in the housing of the starting valve throttle unit is a guide and starting bore in which a starting valve and throttle body is arranged displaceably and rotatably in the direction of its longitudinal axis transversely to the axis of the discharge channel. The starting and throttle body has two closure sections between which a throttle body is arranged. On an inner closure section a starting valve body is formed on the side facing away from the throttle body. This should seal, on the one hand, and leave free on the other hand a starting outlet opening in the bore, which leads outwards from the valve throttle housing. Further valves are known, for example, from DE 27 512 25, DE 10 2007 047 726 and DE 10 2005 037 268.

Further, US 3,817,668 and US 3,746,481 describe melt pumps which use gear wheels as means for controlling the fluid flow. However, these have not proved suitable for the introduction, distribution, control of the flux of hot liquids, in particular hot plastic liquid melts and cannot be used as switching and/or deflecting distributor valves.

The object of the present invention consists in ameliorating or eliminating at least individual disadvantages of the prior art. The invention in particular has the aim of providing a valve in which fluid flows are improved.

This object is achieved by a valve comprising a valve housing and a shut-off element, wherein the valve housing comprises a cavity for receiving the shut-off element, an inlet opening for a fluid to flow into the cavity and an outlet opening for the fluid to flow out of the cavity, wherein the shut-off element comprises a guide body and is arranged linearly movably at least partially in the cavity of the valve housing between the inlet opening and the outlet opening, wherein the shut-off element has at least one recess for flow of the fluid from the inlet opening via the recess to the outlet opening.

Accordingly, the shut-off element comprises at least one recess for fluidic communication of the inlet opening to the outlet opening. Fluidic communication means in this context that a fluid can flow from the inlet opening to the outlet opening. The recess of the shut-off element is therefore a flow-through recess which enables a flow of fluid between the inlet opening and the outlet opening so that the outlet opening is opened. In this case, the shut-off element is arranged at least partially in the cavity of the valve housing between the inlet opening and the outlet opening so that the shut-off element is positioned at least partially in the flow direction of a fluid flowing in the cavity between the inlet opening and the outlet opening. The shut-off element is linearly displaced by linear movement of the shut-off element so that the fluidic communication of the inlet opening with the outlet opening is severed and a fluid flowing from the inlet opening into the cavity of the valve housing is prevented by the shut-off element from flowing further to the outlet opening. As a result, the outlet opening is shut off and closed by the shut-off element. The linear movement of the shut-off element including recess is accomplished continuously so that the outlet opening to be shut off can be variably shut off between 0 and 100%. As a result, a continuous regulation of the fluid flowing through the outlet opening is possible.

The recess of the shut-off element is a recess which reduces the cross-section of the shut-off element with respect to a section of the shut-off element adjacent to the recess. This adjacent section seals the cavity when arranged in the cavity in such a manner that a fluid flowing via the inlet opening into the cavity is prevented from flowing to the outlet opening so that the outlet opening is shut off by the shut-off element. If the shut-off element is moved so that the recess instead of the adjacent section is arranged in the cavity, the shut-off element does not seal the cavity as a result of the smaller cross-section in the region of the recess so that at least an opening fluidically connecting the inlet opening to the outlet opening is formed by the recess in the cavity. Fluid can flow from the inlet opening to the outlet opening via this at least one opening. As a result of the continuous movement of the shut-off element, the recess can be arranged partially in the cavity so that the at least one opening formed by the recess is only formed by the part of the recess arranged in the cavity so that the size of the opening can be changed by varying the proportion of the recess arranged in the cavity.

The recess can, for example, account for 5% to 95%, preferably 10% to 90% or 20% to 80% or 30% to 70% of the cross-sectional area normal to the longitudinal axis of the shut-off element (linear direction of motion) compared to the cross-sectional area of the shutting-off adjacent section. This cross-sectional area of the recess is in particular given at the largest point of the recess in the longitudinal axis, in particular in the case of gradually increasing recesses compared to the adjacent section. The recess, preferably in the form of the tapering, preferably accounts for more than 10%, particularly preferably more than 20%, of the cross-sectional area in the flow direction, i.e. the shut-off element in this case comprises less than 90% or less than 80% of the cross-sectional area, wherein the tapering or the guide body is preferably rotationally symmetrical in the region of the tapering.

The valve according to the invention can be used for the dead-space-free feeding, removal, switching and/or conveyance limitation of highly viscous liquids and/or melts. As a result of the special configuration of the shut-off element, the valve can be used for highly viscous liquids and melts in the area of partially crystalline high-performance thermoplastics such as PEK (polyether ketone), PPEK (polyphthalazine ether ketone), PPS (polyphenylene sulfide) or amorphous high-performance thermoplastics such as PAI (polyamide imide), PPSU (polyphenyl sulfone), PSU (polysulfone) or PES (polyether sulfone) in the corresponding manufacturing processes. The valve according to the invention can also be used in the manufacturing processes of partially crystalline and amorphous thermoplastics such as PA (polyamide), PA6 (polyamide 6; polyamide from caprolactam), PA66 (polyamide 66; polyamide from hexamethylene diamine), PBT (polybutylene terephthalate), POM (polyoxymethylene), PET (polyethylene terephthalate), PP (polypropylene), PE (polyethylene), PTFE (polytetrafluoroethylene). Such methods and manufacturing processes typically comprise extrusion, injection moulding, blow moulding, coating and spray techniques such as, for example, the manufacture of synthetic textile fibres, plastic hoses, plastic foils and films as well as protective and/or insulating coatings for electrical conductor wires.

Preferably the valve according to the invention is used in the manufacture of cellulose or in lines for transporting cellulose solutions. Particularly preferably the valve according to the invention is used in transporting cellulose solutions which are used as extrusion media for the moulding process. In this case, the cellulose concentration is selected in usual sizes for Lyocell processes. The cellulose concentration in the cellulose solution can thus be 4% to 23%, preferably 6% to 20%, in particular 8% to 18% or 10% to 16% (all % information is in mass %).

Preferably the solvent of the cellulose solution is a tertiary aminoxide (amine-N-oxide), particularly preferably N-methylmorpholine N-oxide. Alternatively or additionally it can be an ionic solvent. Such ionic solvents are described, for example, in WO 03/029329; WO 2006/000197 A1; Parviainen et al., RSC Adv., 2015, 5, 69728-69737; Liu et al., Green Chem. 2017, DOI: 10.1039/c7gc02880f; Hauru et al., Cellulose (2014) 21:4471-4481; Fernandez et al. J Membra Sci Technol 2011, p:4; etc. and preferably contain organic cations such as, for example, ammonium, pyrimidium or imidazolium cations, preferably 1,3-dialkyl imidazolium salts such as halides. Water is also used here, preferably as non-solvent of cellulose. Particularly preferred is a solution of cellulose and butyl-3-methyl imidazolium (BMIM), e.g. with chloride as counterion (BMIMC1), or 1-ethyl-3-methyl-imidazolium (also preferably as chloride, acetate or diethyl phosphate) or 1-hexyl-3-methylimidazolium or 1-hexyl-1-methylpyrrolidinium (preferably with a bis(trifluoromethyl sulfonyl)amide anion), and water. Further ionic solvents are 1,5-diazabicyclo[4.3.0]non-5-enium, preferably as acetate; 1-ethyl-3-methylimidazolium acetate, 1.3-dimethylimidazolium acetate, 1-ethyl-3-methylimidazolium chloride, 1-butyl3-methylimidazolium acetate, 1-ethyl-3-methylimidazolium diethyl phosphate, 1-methyl-3-methylimidazolium dimethyl phosphate, 1-ethyl-3-methylimidazolium formate, 1-ethyl-3-methylimidazolium octanoate, 1,3-diethylimidazolium acetate and 1-ethyl-3-methylimidazolium propionate.

According to a preferred embodiment, the guide body of the shut-off element is prism-shaped, preferably substantially cylindrical. As a result, the shut-off element can easily be moved linearly in the cavity in the longitudinal direction of the guide body. Furthermore, a simple manufacture of the shut-off element is possible. The recess is in this case a cut-out in the prism-shaped guide body so that the constant cross-section of the prism-shaped guide body perpendicular to the longitudinal axis is smaller in the region of the recess. As a result, in the region of the recess a smaller cross-section is shut off by the shut-off element so that fluid can pass the shut-off element and flow to the outlet opening.

According to a particularly preferred embodiment, the recess is a tapering in the guide body, wherein the tapering is preferably arranged perpendicularly to the longitudinal axis of the (prism-shaped) guide body. Thus, the recess forms a groove running around the guide body perpendicular to the longitudinal axis along which a fluid can flow around the shut-off element transversely to the longitudinal axis of the prims-shaped guide body. As a result, fluid can flow via the inlet opening into the cavity of the valve housing and further along the tapering to the outlet opening. The groove preferably has a cross-sectional area delimited by a parabola so that the groove forms a through-channel recess running around the guide body. Preferably the tapering is rotationally symmetrical relative to the longitudinal axis of the guide body. Preferably the cross-section of the guide body initially decreases monotonically in the region of the tapering in the direction of the longitudinal axis and then increases monotonically. Preferably the tapering runs between a first end point and a second end point which are spaced apart from one another along the longitudinal axis of the guide body in the direction of a central longitudinal axis of the guide body.

According to a further preferred embodiment, the recess is an aperture in the guide body of the shut-off element. As a result, a simple manufacture of the recess is possible. Advantageously the aperture is a cylindrical bore through the guide body which is preferably aligned perpendicular to the longitudinal axis of the prism-shaped guide body. The aperture can fluidically connect the inlet opening and the outlet opening of the valve housing so that a fluid can flow from the inlet opening through the aperture to the outlet opening.

It is favourable if the shut-off element has a further recess. As a result, the fluid can flow due to linear movement of the shut-off element via the recess and/or the further recess from the inlet opening to the outlet opening. In this case, the shut-off element is positioned by linear movement in the valve housing in such a manner that the recess and/or the further recess fluidically connects the inlet opening to the outlet opening so that a fluid can flow from the inlet opening to the outlet opening. With the further recess, a sample of a material can be taken both during continuous production and also during discharging (for example, with the aid of a start-up valve. Furthermore a relief of pressure can be performed with the further recess.

Furthermore, it is favourable if the further recess is preferably a prism-shaped aperture, particularly preferably a cylindrical further aperture, in the guide body of the shut-off element, As a result, a simple manufacture of the further recess is possible. If the recess is a cylindrical aperture, the diameter of the recess can be smaller than, equal to or larger than the diameter of the cylindrical further aperture of the further recess. If the diameter is the same, the further recess can be used as redundancy to the aperture. If the shapes of the recess and the further recess are different or the diameters of the cylindrical aperture and the cylindrical further aperture are different, different flow rates can be achieved in the aperture and in the further aperture.

According to a preferred embodiment, the further recess is a prism-shaped aperture in the guide body of the shut-off element, wherein preferably a longitudinal axis of the prism-shaped guide body and a longitudinal axis of the prism-shaped aperture enclose an angle between 45° and 90°, particularly preferably between 60° and 85°, in particular between 70° and 80°. Advantageously as a result, a further outlet opening of the valve housing in one position of the shut-off element can be fluidically connected to the inlet opening, wherein the further outlet opening is configured for a sampling. Preferably the further outlet opening is arranged adjacent to the outlet opening on the same side of the valve housing as the outlet opening so that the recess can be configured to run perpendicular to the longitudinal axis of the prism-shaped guide body and the further recess can be configured to run obliquely to the longitudinal axis of the prism-shaped guide body. Preferably in an arrangement of the shut-off element in the cavity in which the further recess adjoins the further outlet opening, the further recess is configured for further conducting the fluid from the inlet opening to the further outlet opening. Thus, the inlet opening is fluidically connected via the further recess to the further outlet opening.

According to a further preferred embodiment, the cavity comprises a substantially prism-shaped first section and a substantially prism-shaped second section, wherein the shut-off element is at least partially received linearly movably in the second section. Preferably the first section is fluidically connected to the second section so that without the shut-off element arranged in the second section, fluid can flow from the first section into the second section and conversely. Particularly preferably the base area of the prism-shaped second section has the same shape as the base area of the prism-shaped guide body of the shut-off element. In this case, the base area of the guide body can be smaller than or the same as the base area of the second section so that the shut-off element can be received in the second section with a tolerance of greater than or equal to 0. As a result, an optimal receipt of the shut-off element in the cavity of the valve housing is possible.

According to a particularly preferred embodiment, the first and the second substantially prism-shaped sections intersect at an angle between 30° and 90°, preferably between 60° and 90°, particularly preferably between 80° and 90°, in particular of precisely 90°. Particularly preferably the inlet opening and the outlet opening are arranged on the first section so that fluid can flow in the first section and the shut-off element is received in the second section. As a result, the axis along which the shut-off element can be moved and the axis which is arranged in the flow direction of the fluid in the valve housing enclose an angle between 30° and 90°, preferably between 60° and 90°, particularly preferably between 80° and 90°, in particular of precisely 90°. Thus, the shut-off element can be moved obliquely or transversely to the flow direction so that an optimal shut-off of the fluid flow in the valve housing is possible.

It is favourable if the inlet opening is arranged on a first base surface of the substantially prism-shaped first section, in particular is congruent with a first base surface of the substantially prism-shaped first section. As a result, an optimal dead-space-free flow of the fluid into the first section of the cavity into the valve housing is possible. Preferably the fluid flows from the inlet opening via the first section to the second section of the cavity, from where, depending on the position of the shut-off element, it can flow via the recess further to the outlet opening or can be shut off by the shut-off element and prevented from flowing further.

Furthermore, it is favourable if an outlet opening is arranged on a second base surface of the substantially prism-shaped first section opposite the first base surface, in particular is congruent with a second base surface of the substantially prism-shaped first section opposite the first base surface. Preferably the inlet opening and the outlet opening are arranged on a longitudinal axis of the first section so that an optimal fluid flow can be formed by the cavity of the valve housing. Particularly preferably the axis along which the shut-off element is movable is aligned perpendicular to the longitudinal axis of the first section so that the shut-off element is movable perpendicular to the fluid flow in the first section of the cavity. As a result, the fluid can be optimally shut off in the valve housing with the aid of the shut-off element.

For better fluid flow the first section is substantially cylindrical wherein the diameter of the substantially cylindrical first section in a region of intersection of the first section with the second section is 1% to 20%, preferably 5% to 10% smaller than in the case of the first base surface.

According to a preferred embodiment, the second section is a cylindrical bore passing through the valve housing, wherein the bore forms a first and a second aperture on two opposite sides of the valve housing. As a result, a simple and cost-effective manufacture of the valve housing is possible, since the second section of the cavity is produced by a bore. The shut-off element can thus simply be arranged in the second section of the cavity of the valve housing and can be removed again from the second section of the cavity for maintenance purposes.

According to a particularly preferred embodiment, the guide body of the shut-off element is substantially cylindrical, wherein the longitudinal axis of the cylindrical second section coincides with the longitudinal axis of the substantially cylindrical guide body of the shut-off element. As a result, an optimal receipt of the shut-off element in the second section of the cavity is possible.

According to a particularly preferred embodiment, the shut-off element in the cavity has a tolerance so that a gap is formed in the cavity between the guide body of the shut-off element and the valve housing through which fluid can flow. As a result, a permanent storage of fluid in the valve can be reduced or even avoided. Through the gap a defined fluid flow can flow around the guide body of the shut-off element so that no dead space is formed in the cavity in which fluid can be deposited. As a result of the freedom from dead space long dwell times of the fluid in the valve according to the invention are prevented. Advantageously the recess of the shut-off element is configured in such a manner that this does not form any dead space when a fluid flows in and enables an optimal transfer of the fluid. This is achieved, for example, with a narrowing as recess. The tolerance is in particular (also) achieved in the shut-off section adjacent to the narrowing.

According to a further particularly preferred embodiment, a seal is arranged between the guide body of the shut-off element and the cavity which seals the shut-off element with respect to the valve housing. This has the advantage that a complete sealing of the shut-off element is possible.

For better guidance of the shut-off element in the cavity, the substantially cylindrical guide body of the shut-off element is at least partially received in the bore in such a manner that the shut-off element projects at least partially from the second aperture.

It is preferable if, in the region of the second aperture, in which the shut-off element projects from the valve housing, sealing rings, preferably leakage rings are mounted in a groove milled into the guide body of the shut-off element. These sealing rings are preferably constructed of a flexible plastic ring which is resistant to the fluid and from a cover ring. Particularly preferably the sealing rings are arranged on the valve housing in the second section of the cavity at the second aperture so that these seal the gap in the second section of the cavity between the valve housing and the guide body of the shut-off element. Depending on the viscosity of the fluid transported in the valve, there can be scenarios in which the quantity of fluid which emerges from the valve housing through the gap in the second section of the cavity between the valve housing and the guide body is too large. Particularly preferably in this case the sealing rings can be made to bulge inwards in the second section of the cavity in the direction of the guide body by tightening fastening screws which fasten the sealing rings on the valve housing so that the fluid flow in the gap in the second section of the cavity between the guide body and the valve housing is reduced.

In order to move the shut-off element in the cavity, it is favourable if the valve has a drive for linear movement of the shut-off element, wherein the drive engages at an end of the shut-off element projecting from the second aperture. As a result, the shut-off element can be arranged in a space-saving manner partially in the cavity of the valve housing.

The invention further relates to a valve system with a valve as described herein, wherein a start-up valve is provided in a further cavity which leads to the inlet opening of the valve.

In a preferred embodiment of the valve system, the start-up valve comprises:
a start-up valve cavity which is connected to the further cavity and in which a start-up valve shut-off element is received,
a start-up valve inlet opening for flow of a fluid from the further cavity into the start-up valve cavity,
a start-up valve outlet opening for flow of the fluid from the start-up valve cavity,
wherein the start-up valve shut-off element has a start-up valve guide body for shutting off the start-up valve inlet opening which is arranged movably in the start-up valve cavity.

It is favourable if the shut-off element of the valve oscillates regularly for flushing a gap in the cavity between the valve housing and the guide body of the shut-off element. As a result, the flushing of the gap can be improved and any cracking of the fluid in the gap can be further reduced. Preferably the shut-off element oscillates in a linear motion in the direction of the longitudinal axis of the cylindrical second section of the cavity. Particularly preferably the amplitude of the oscillating movement is between 5 and 10 mm.

The invention further relates to a method for transporting fluids, characterized in that a fluid is transported in a valve system as described herein. In this case, the fluid flows in particular along the further cavity and if the valve is open, through the cavity to the outlet opening. If the valve is open, the fluid flows through the start-up valve cavity to the start-up valve outlet opening.

It is advantageous if the valve system is operated in a start-up mode wherein the inlet opening is shut off with the shut-off element and the start-up valve guide body releases the start-up valve cavity.

Advantageously the valve system is operated in a production mode, preferably after operating in the start-up mode, wherein the recess is brought into the region of the cavity and the start-up valve inlet opening is closed with the start-up valve guide body. In this way pressure relief and a slower pressure rise in the valve can be achieved.

Preferably a pressure relief is carried out in the production mode wherein the start-up valve is opened partially or completely for pressure relief of the valve.

Advantageously in the production mode or in the start-up mode a sample of fluid is taken via the further recess.

The invention is explained further hereinafter with reference to non-restrictive exemplary embodiments shown in the drawings.

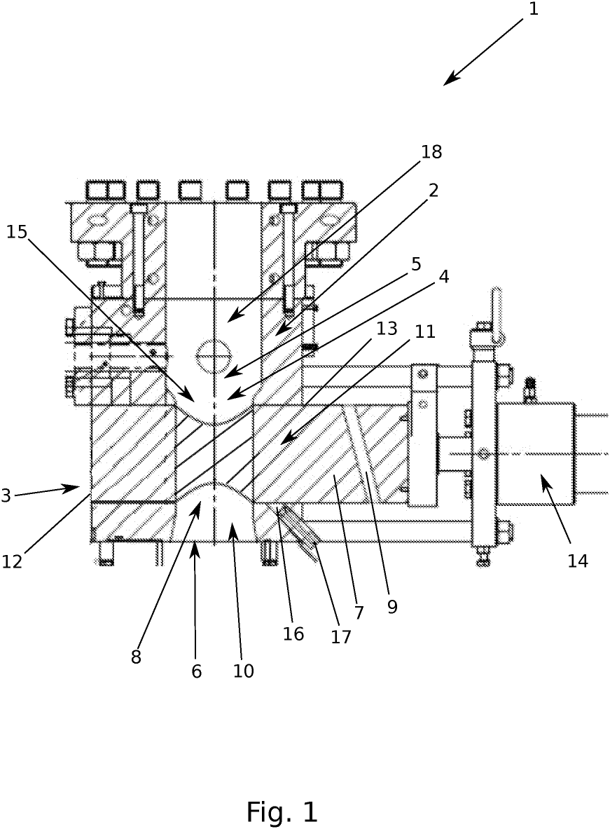

FIG. 1 shows schematically a valve according to the invention with a valve housing and a shut-off element in an open state and a closed sampling;

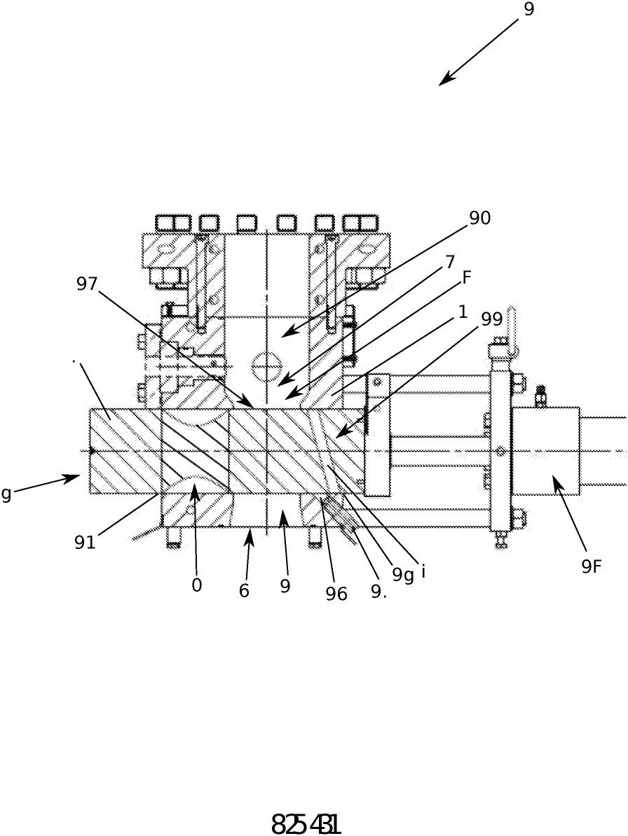

FIG. 2 shows schematically the valve according to FIG. 1 in a shut-off state;

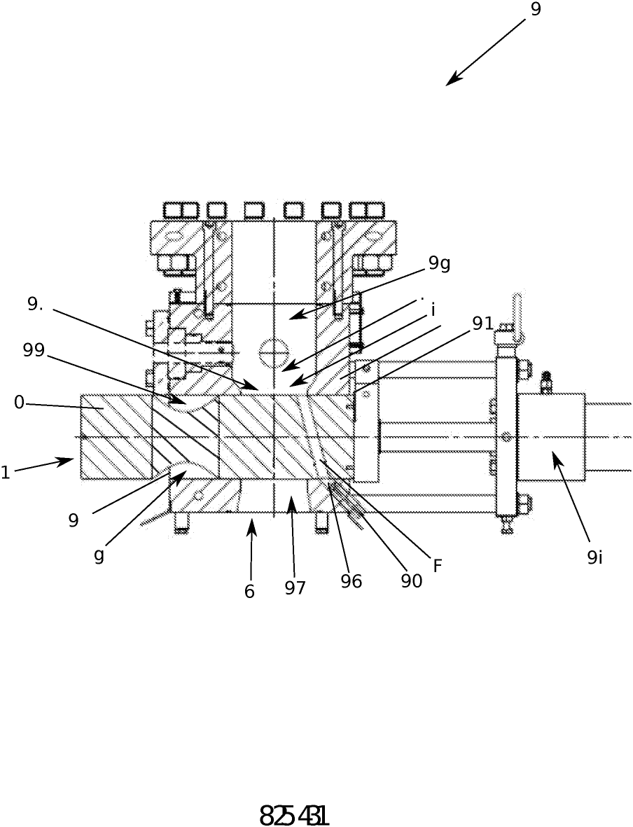

FIG. 3 shows schematically the valve according to FIG. 1 in a shut-off state and an opened sampling;

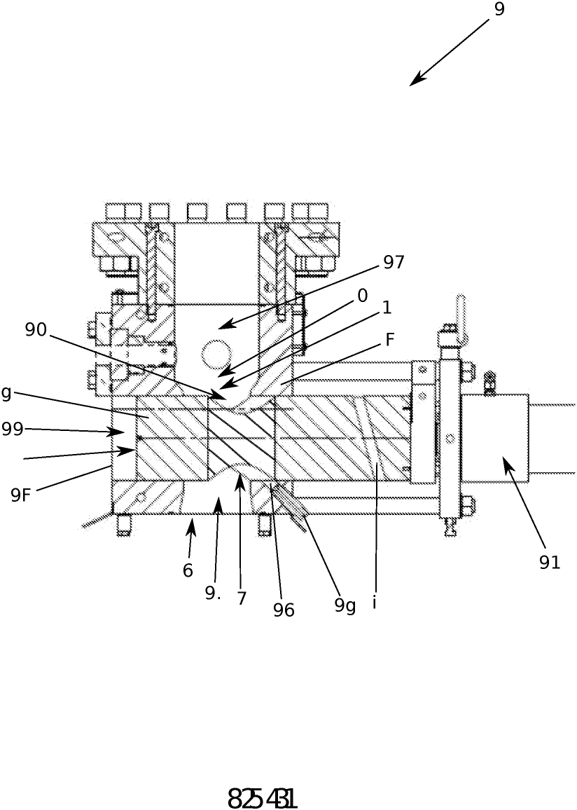

FIG. 4 shows schematically the valve according to FIG. 1 in a partially opened state and an opened sampling;

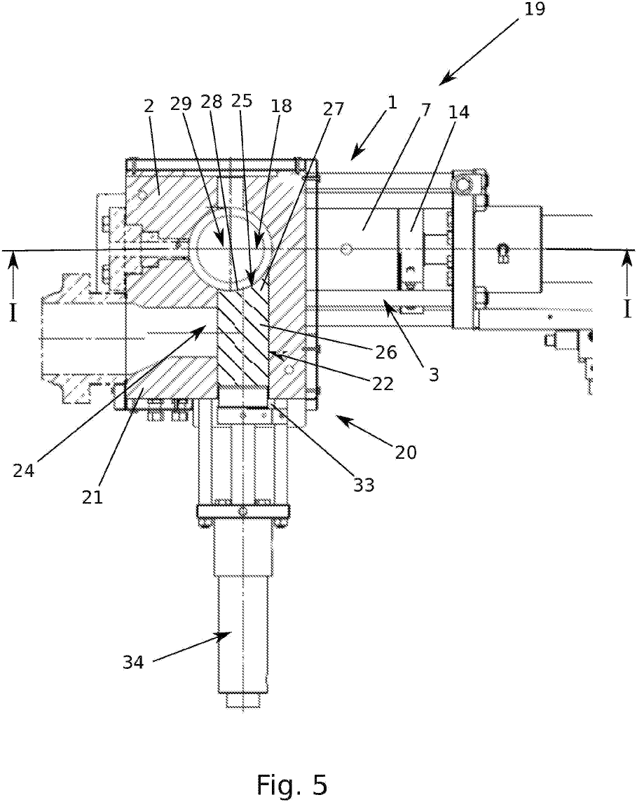

FIG. 5 shows schematically a start-up valve with an additional valve according to FIG. 1, wherein the start-up valve is in a shut-off state (shown in section);

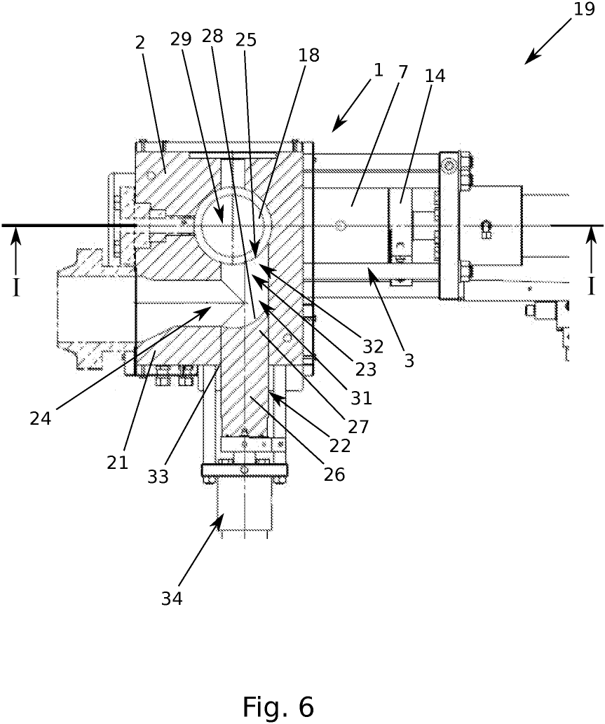

FIG. 6 shows schematically the start-up valve according to FIG. 5 wherein the start-up valve is in an opened state.

FIGS. 1 to 4 show a valve 1 according to the invention comprising a valve housing 2 and a shut-off element 3, wherein the valve housing 2 has a cavity 4 for receiving the shut-off element 3, an inlet opening 5 for flow of a fluid into the cavity 4 and an outlet opening 6 for flow of the fluid from the cavity 4. The shut-off element 3 comprises a substantially cylindrical guide body 7 and is arranged linearly movable in the cavity 4 of the valve housing 2 between the inlet opening 5 and the outlet opening 6. Furthermore, the guide body 7 has a recess 8 for flow of the fluid from the inlet opening 5 via the recess 8 to the outlet opening 6. The recess 8 is a tapering in the guide body 7, wherein the tapering is arranged perpendicular to the longitudinal axis of the substantially cylindrical guide body 7. Furthermore, the shut-off element 3 has a further recess 9 which is a cylindrical aperture in the guide body 7 of the shut-off element 3. The longitudinal axis of the prism-shaped guide body 7 and the longitudinal axis of the cylindrical further recess 9 enclose an angle of 75°.

The cavity 4 comprises a substantially cylindrical first section 10 and a cylindrical second section 11, wherein the shut-off element 3 is partially received linearly movably in the second section 11. In this case, the longitudinal axis of the cylindrical second section 11 coincides with the longitudinal axis of the substantially cylindrical guide body 7 of the shut-off element 3. The shut-off element has a tolerance in the second section 11 of the cavity 3 so that a gap is formed in the cavity 4 between the guide body 7 of the shut-off element 3 and the valve housing 2 through which the fluid can flow. As a result, any permanent deposition of fluid in the valve 1 can be reduced or even avoided.

The first 10 and second 11 section intersect at an angle of 90° so that the first section 10 is arranged perpendicularly to the second section 11. As a result, the first 10 and second 11 section form two tunnels arranged perpendicularly to one another which form a cross-shaped cavity 4. The inlet opening 5 is arranged on a first base surface of the substantially cylindrical first section 10 which is congruent with the first base surface of the first section 10. The outlet opening 6 is arranged on a second base surface of the substantially cylindrical first section 10 opposite the first base surface, which is congruent with the second base surface of the first section 10. Thus, the inlet opening 5 and the outlet opening 6 are arranged on the longitudinal axis of the substantially cylindrical first section 10. The first section 10 intersects the second section 11 of the cavity 4 in a region which is arranged between the inlet opening 5 and the outlet opening 6. Since the shut-off element 3 is received in the second section 11, the shut-off element 3 is arranged between the inlet opening 5 and the outlet opening 6. In the embodiment shown the second section 11 is a cylindrical bore passing through the valve housing 2, wherein the bore forms a first 12 and a second 13 aperture on two opposite sides of the valve housing 2. The guide body 7 of the shut-off element 3 is received in the bore in such a manner that the shut-off element 3 projects partially from the second aperture 13. The valve 1 has a drive 14 for linear movement of the shut-off element 3 in the direction of the longitudinal axis of the substantially cylindrical guide body 7, wherein the drive 14 engages at the end of the shut-off element 3 projecting from the second aperture 13.

In the embodiment shown, in the intersection region 15 of the first section 10 with the second section 11 the diameter of the first section 10 is 20% smaller than in the case of the first base surface at the inlet opening 5. The recess 8 is configured in such a manner that it is an annular cut-out perpendicular to the longitudinal axis of the substantially cylindrical guide body 7. The width of the annular cut-out is equal to the diameter of the first section 10 in the intersection region 15. Furthermore, the annular cut-out has a cross-section which is delimited by a parabola and an axis parallel to the directrices of the parabola. Due to the recess 8 in the guide body 7 the shut-off element 3 is bone-shaped, wherein the constant diameter of the substantially cylindrical guide body 7 is reduced as a result of the recess 8 by up to 40%.

The valve housing 2 has a further outlet opening 16 on which a sampling valve 17, e.g. a ball cock, is arranged for opening and closing the further outlet opening 16. The further outlet opening 16 is fluidically connected to the second section 11 of the cavity 4 so that fluid can flow from the second section 11 of the cavity 4 via the further outlet opening 16 and the opened sampling valve 17 from the valve 1. In this case, the further outlet opening 16 is arranged on the same side of the second section 11 of the cavity 4 as the outlet opening 6, wherein the further outlet opening 16 is arranged on an imaginary extension of the second base surface of the first section 10 of the cavity 4.

In the embodiment of the valve 1 according to the invention shown in FIGS. 1 to 4, a fluid flows via a cylindrical pipe section 18 to the circular inlet opening 5 of the valve housing 2 adjacent to the pipe section 18. Via the inlet opening 5 the fluid flows further into the first section 10 of the cavity 4 of the valve housing 2 to the intersection region 15 in which the second section 11 intersects the first section 10 of the cavity 4. The shut-off element 3 is received in the second section 11 wherein the shut-off element 3 is positioned in FIG. 1 in such a manner that in the second section 11 the recess 8 is arranged in the intersection region 15 of the first section 10 with the second section 11. Since in the intersection region 15, the cross-section of the shut-off element 3 is smaller than the cross-section of the cylindrical second section 11 as a result of the recess 8 in the substantially cylindrical guide body 7, the recess 8 forms an opening in the intersection region 15 between the shut-off element 3 and the valve housing 2 so that the fluid in the first section 10 of the cavity 4 flows through the intersection region 15 to the outlet opening 6. Since a gap is formed in the second section 11 of the cavity 4 between the guide body 7 of the shut-off element 3 and the valve housing 2, a defined quantity of fluid can flow into the gap for flushing the gap.

With the aid of the drive 14 the shut-off element 3 can be moved so that, as shown in FIG. 2, the recess 8 is no longer arranged in the intersection region 15 of the first section 10 and the second section 11 of the cavity 4. In this case, neither the recess 8 nor the further recess 9 is arranged in the intersection region 15 and is fluidically connected to the first section 10 of the cavity 4. Since the substantially cylindrical guide body 7 of the shut-off element 3 fills the entire cross-section of the second section 11 of the cavity 4 apart from a gap, with the positioning of the shut-off element 3 shown in FIG. 2, the intersection region 15 is completely filled by the guide body 7 of the shut-off element 3 apart from a small gap so that the guide body 7 shuts off the intersection region 15. Thus, the region of the first section 10 of the cavity 4 which adjoins the inlet opening 5 is shut off by the shut-off element 3 from the region of the first section 10 which adjoins the outlet opening 6. As a result, apart from a small quantity via the gap, no fluid can flow into the first section 10 of the cavity 4 from the inlet opening 5 to the outlet opening 6 or to the further outlet opening 16.

By moving the shut-off element 3, this can be arranged as shown in FIG. 3 in the second section 11 of the cavity 4 in such a manner that the further recess 9 is arranged partially in the intersection region 15 in such a manner that the further recess 9 fluidically connects the region of the first section 11 which adjoins the inlet opening 5 to the further outlet opening 16. Since the longitudinal axis of the substantially cylindrical guide body 7 and the longitudinal axis of the cylindrical further recess 9 enclose an angle of, for example, 75°, the further recess 9 is fluidically connected to the inlet opening 5 but not to the outlet opening 6 but to the further outlet opening 16 offset with respect to the outlet opening 6. Via the aperture arranged obliquely to the longitudinal axis in the guide body 7, which forms the further recess 9, fluid can flow from the inlet opening 5 via the first section of the cavity 4 to the further outlet opening 16 at which a sampling of the fluid can take place. Since the further recess 9 is not fluidically connected to the region of the first section 10 which adjoins the outlet opening 6 and since the recess 8 is not arranged in the intersection region 15 if the first section 10 with the second section 11 of the cavity 4, the outlet opening 6 is not fluidically connected to the inlet opening so that no fluid flows through the outlet opening 6 from the valve 1.

FIG. 4 shows the valve 1 according to the embodiment shown in FIG. 1 wherein the shut-off element 3 is arranged in the second section 11 of the cavity 4 in such a manner that the recess 8 is positioned partially in the intersection region 15 of the first section 10 and second section 11 of the cavity 4. In this case, a part of the recess 8 which is not positioned in the intersection region 15 adjoins the further outlet opening 16 so that the opening formed by the recess 8 in the intersection region 15 fluidically connects the inlet opening 5 both to the outlet opening 6 and also to the further outlet opening 16. Thus, a fluid which flows into the first section 10 of the cavity 4 via the inlet opening 5 can flow further via the opening formed with the aid of the recess 8 through the intersection region 15 to the outlet opening 6 and to the further outlet opening 16. In this case, the opening to the outlet opening 6 is smaller than in the positioning of the shut-off element 3 shown in FIG. 1 so that less fluid can flow through the outlet opening 6 than in the positioning shown in FIG. 1. As a result, for example, a flow of fluid through the outlet opening 6 and also a sampling of the fluid via the further outlet opening 16 is possible simultaneously. As a result of the continuous movement of the shut-off element 3 in the second section 11 of the cavity 4, the fraction of the recess 8 arranged in the intersection region 15 can be varied continuously between 0% and 100% so that the size of the opening formed by the recess 8 for the flow of fluid can be varied continuously. As a result, it is possible to continuously regulate the flow of fluid through the valve 1.

The valve 1 according to the invention can be used, for example, in the manufacturing process of a cellulose/aminoxide solution. As a result of the configuration of the shut-off element 3, spinning mass is prevented from being able to accumulate and decompose in dead spaces of plants. Even in cases of fairly long storage of spinning mass in the valve 1, the shut-off element 3 cannot seize up in the valve housing 2 since the shut-off element 3 can be set periodically in rotation or in a periodic translational motion and flushed. Thus, the present invention also provides a method for transporting a solution of cellulose in an aqueous tertiary aminoxide through a valve 1 in which the flow rate of the cellulose solution in the valve housing 2 can be set periodically and varied in order to ensure that a safe diversion, distribution and safe transport of the cellulose/aminoxide solution.

The embodiment of the valve 1 according to the invention shown in FIGS. 1 to 4 can be used as part of a valve system 19. For this purpose, as shown in FIGS. 5 and 6, the valve 1 according to the invention is combined with a start-up valve 20. The start-up valve 20 comprises a valve housing 21 and a shut-off element 22, wherein the valve housing 21 of the start-up valve 20 comprises a cavity 23 for receiving the shut-off element 22, an inlet opening 25 for inflow of a fluid into the cavity 23 and an outlet opening 24 for outflow of the fluid from the cavity 23 of the start-up valve 20. The shut-off element 22 of the start-up valve 20 has a guide body 26 and a shut-off projection 27 for shutting off the inlet opening 25 and is arranged movably in the cavity 23 of the valve housing 21 of the start-up valve 20. The shut-off projection 27 has a curved abutting surface 28 for abutting against the inlet opening 25. The curved abutting surface 28 is circular-arc-shaped in order to be able to abut against the inlet opening 25 of the valve housing 21 of the start-up valve 20 which is arranged on a lateral surface of a cylindrical further cavity 29. In this case, the inlet opening 25 connects the cavity 23 and the further cavity 29 located perpendicularly on the cavity 23. The guide body 26 of the shut-off element 22 of the start-up valve 20 is substantially cylindrical wherein the shut-off projection 27 is arranged on a base surface 30 of the substantially cylindrical guide body 26. The cavity 23 comprises a cylindrical first section 31 and a second section 32 which is arranged between the first section 31 and the further cavity 29. In this case, the cylindrical further cavity 29 is arranged in the longitudinal direction of the cylindrical first section 31 of the cavity 23, wherein the longitudinal axis of the cylindrical further cavity 29 is perpendicular to the longitudinal axis of the cylindrical first section 31. The shut-off projection 27 has the same shape as the second section 32 of the cavity 29 of the valve housing 21 of the start-up valve 20. The shut-off element 22 of the start-up valve 20 is arranged in the cavity 23 in such a manner that the longitudinal axis of the cylindrical first section 31 of the cavity 23 coincides with the longitudinal axis of the substantially cylindrical guide body 26 of the shut-off element 22.

The outlet opening 24 is arranged on the lateral surface of the cylindrical first section 31 of the cavity 23. The first section 31 of the cavity 23 is a cylindrical bore passing through the valve housing 21 of the start-up valve 20 which forms an aperture 33 on the side opposite the second section 32 of the cavity 23. The guide body 26 is received in the bore in such a manner that the shut-off element 22 projects partially from the aperture 33. The start-up valve 20 has a drive 34 for linear movement of the shut-off element 22 in the direction of the longitudinal axis of the substantially cylindrical guide body 26, wherein the drive 34 engages at the end of the shut-off element 22 projecting from the aperture 33.

In FIG. 5 the start-up valve 20 is shown in the closed state, wherein the curved abutting surface 28 of the shut-off projection 27 abuts against the inlet opening 25. In addition, the guide body 26 of the shut-off element 22 abuts against the outlet opening 24 and shuts this off so that no fluid can flow from the inlet opening 25 into the cavity 23 of the start-up valve 20 and further to the outlet opening 24. In this position the shut-off projection 27 is arranged in the second section 32 of the cavity 23 and the guide body 26 is arranged in the first section 31 of the cavity 23. In order to avoid a dead space of the fluid in the start-up valve 20, a gap can be formed in the cavity 23 between the valve housing 21 and the guide body 26 so that fluid can flow through the inlet opening 25 via the gap into the cavity 23 and further to the outlet opening 24. As a result, a long dwell time of the fluid in the start-up valve 20 can be avoided. During linear movement of the shut-off element 22 of the start-up valve 20 in the longitudinal direction of the cylindrical first section 31 of the cavity 23 in the direction of the aperture 33, the guide body 26 of the shut-off element 22 moves past the outlet opening 24. During the passing of the guide body 26 the outlet opening 24 is continuously opened so that a fluid can flow from the further cavity 29 through the inlet opening 25 into the cavity 23 and further to the outlet opening 24. In this case, the fluid in the cavity 23 is guided through the base surface 30 of the substantially cylindrical guide body 26 and the curved abutting surface 28 of the shut-off projection 27 in such a manner that the flow of the fluid in the cavity 23 is improved. During further linear motion of the shut-off element 22 in the direction of the aperture 33 the outlet opening 24 is opened further until the guide body 26 no longer covers the outlet opening 24 and, as shown in FIG. 6, the outlet opening 24 is completely opened. In this case, the base surface 30 of the substantially cylindrical guide body 26 contacts the outlet opening 24 on the side facing away from the inlet opening 25. With the aid of the base surface 30 and the curved abutting surface 28 of the shut-off projection 27, the fluid in the cavity 23 is guided in the direction of the outlet opening 24 wherein the flow of the fluid is improved compared to a shut-off element without shut-off projection 27.

The further cavity 29 of the start-up valve 20 corresponds to the cylindrical pipe section 18 according to FIGS. 1 to 4. The flowing fluid passes via the inlet opening 5 of the valve housing 2 of the valve 1 according to the invention via the first section 11 of the cavity 4 and the recess 8 of the shut-off element 3 to the outlet opening 6 of the valve housing 2 of the valve 1 according to the invention and thus flows in the cylindrical pipe section 18 from where it passes via the inlet opening 25 of the valve housing 21 of the start-up valve 20 to the outlet opening 24. The valve 1 shown in FIG. 1 corresponds here to the section I-I shown in FIGS. 5 and 6.

1. A valve comprising: a valve housing and a shut-off element; wherein the valve housing comprises a cavity for receiving the shut-off element; an inlet opening for a fluid to flow into the cavity and an outlet opening for the fluid to flow out of the cavity; wherein the shut-off element comprises a guide body and is arranged linearly movably at least partially in the cavity of the valve housing between the inlet opening and the outlet opening; wherein the shut-off element has at least one recess for flow of the fluid from the inlet opening via the recess to the outlet opening; wherein the shut-off element has a further recess for flow of the fluid from the inlet opening via the further recess to the outlet opening, and the further recess is a prism-shaped aperture in the guide body of the shut-off element: wherein the valve housing has a further outlet opening and in one position of the shut-off element, the further outlet opening can be fluidically connected to the inlet opening via the further recess.

2. The valve according to claim 1, characterized in that the guide body of the shut-off element is prism-shaped, preferably substantially cylindrical.

3. The valve according to claim 1 , characterized in that the recess is a tapering in the guide body, wherein the tapering is preferably arranged perpendicularly to a longitudinal axis of the guide body.

4. The valve according to claim 1, characterized in that the recess is an aperture in the guide body of the shut-off element.

5. (canceled)

6. The valve according to claim 1, characterized in that aperture a longitudinal axis of the guide body and a longitudinal axis of the prism-shaped further recess enclose an angle between 45° and 90° .

7. The valve according to claim 1, characterized in that the cavity comprises a substantially prism-shaped first section and a substantially prism-shaped second section, wherein the shut-off element is at least partially received linearly movably in the substantially prism-shaped second section.

8. The valve according to claim 7, characterized in that the first substantially prism-shaped section and the second substantially prism-shaped section intersect at an angle between 30° and 90°.

9. The valve according to claim 7, characterized in that the inlet opening is arranged on a first base surface of the substantially prism-shaped first section in particular is congruent with a first base surface of the substantially prism-shaped first section.

10. The valve according to claim 9, characterized in that an outlet opening is arranged on a second base surface of the substantially prism-shaped first section opposite the first base surface, in particular is congruent with a second base surface of the substantially prism-shaped first section opposite the first base surface.

11. The valve according to claim 7, characterized in that the second substantially prism-shaped section is a cylindrical bore passing through the valve housing, wherein the bore forms a first and a second aperture on two opposite sides of the valve housing.

12. The valve according to claim 11, characterized in that the guide body of the shut-off element is substantially cylindrical, wherein the longitudinal axis of the cylindrical second section coincides with the longitudinal axis of the substantially cylindrical guide body of the shut-off element.

13. The valve according to claim 11, characterized by a drive for linear movement of the shut-off element, wherein the drive engages at an end of the shut-off element projecting from the second aperture.

14. A valve system, characterized by a valve according claim 1, wherein a start-up valve is provided in a further cavity which leads to the inlet opening of the valve.

15. The valve system according to claim 14, characterized in that the start-up valve comprises:
a start-up valve cavity which is connected to the further cavity and in which a start-up valve shut-off element is received,
a start-up valve inlet opening for flow of a fluid from the further cavity into the start-up valve cavity; and
a start-up valve outlet opening for flow of the fluid from the start-up valve cavity
wherein the start-up valve shut-off element has a start-up valve guide body for shutting off the start-up valve inlet opening which is arranged movably in the start-up valve cavity.

16. A method for transporting fluids, characterized in that the fluid flow is regulated and/or controlled in a valve according to claim 1.

17. The method according to claim 16, characterized in that the shut-off element of the valve oscillates regularly for flushing a gap in the cavity between the valve housing and the guide body of the shut-off element.

18. A method for transporting fluids, characterized in that a fluid is transported in a valve system according to claim 14.

19. The method according to claim 18, characterized in that the valve system is operated in a start-up mode wherein the inlet opening is shut off with the shut-off element and the shut-off valve guide body releases the start-up valve cavity.

20. The method according to claim 18 characterized in that the valve system is operated in a production mode, preferably after operating in the start-up mode, wherein the recess is brought into the region of the cavity and the start-up valve inlet opening is closed with the start-up valve guide body.

21. The valve according to claim 1, characterized in that a sampling valve for opening and closing the further outlet opening is arranged at the further outlet opening.
